(19) United States
(12) Patent Application Publication
(10) Pub. No.: US 2004/0079296 A1
(43) Pub. Date: Apr. 29, 2004

(54) Animal training apparatus and method

(76) Inventor: Juan Manuel Villanueva, Vista, CA (US)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/283,621

(22) Filed: Oct. 29, 2002

(51) Int. Cl. A01K 37/00

(52) U.S. Cl. 119/712

(57) ABSTRACT

A device for training a dog or other animal to not jump up on persons. The device is formed by a plate releasably securable to the forward surface of a user's thigh proximate to the knee. The plate has a forwardly projecting prong. The user raises his/her leg to contact the prong against the dog during the jump up action, thereby irritating the dog and discouraging the behavior.

### FIELD OF THE INVENTION

This invention relates to animal training devices and more particularly to devices and methods for discouraging animal jump-up behaviors.

BACKGROUND OF THE INVENTION

The domestication of dogs and other animals as pets and useful companions has long involved the need for behavior modification training. One particularly undesirable behavior is the unwanted jumping up by the dog onto a standing person. A typical training technique to discourage such behavior involves the application of a negatively reinforcing event after the occurrence of the particular undesirable behavior. A typical negatively reinforcing event would be the application of a sensory irritant such as an electric shock as disclosed in Clark U.S. Pat. No. 5,158,039, irritating noises as disclosed in Curtis U.S. Pat. No. 3,570,457, or a mildly painful physical event such as disclosed in Baer U.S. Pat. No. 5,024,183. It is widely known that the best training occurs when the negatively reinforcing event occurs soon after or contemporaneously with the occurrence of the unwanted behavior. In other words, to be most effective the negatively reinforcing event should occur during the “jumping-up” action.

Of the prior devices, some require the inconvenience of being carried and a degree of user vigilance in watching for the misbehavior. Others are not readily adaptable to be useful in training different types of animals. Others such as disclosed in Clark supra are susceptible to accidental shock to the user, are uncomfortable to wear, and expensive to manufacture and maintain. Many prior devices are limited or even non-adjustable in the strength of the negatively reinforcing event. An event which is distasteful to an animal the first few times it is used may become ineffective after prolonged use.

It is, therefore, desirable to provide an animal training apparatus which addresses some of the above-identified problems.

### SUMMARY OF THE INVENTION

The principal and secondary objects of this invention are to provide an apparatus for discouraging animal behaviors such as jumping up by dogs, which is adaptable to different types of animals, which adjustable for use by different sized individuals, and which is inexpensive to manufacture, maintain and operate.

These and other valuable objects are achieved by an adjustable harness releasably attachable to a user's leg above the knee, having a front connector for temporarily securing a carrier, carrying a negatively reinforcing event-causing device mounted thereon. The device can include one or more blunted prongs of adjustable sharpness for inducing a mildly painful jab. Another carrier is adapted to carry a noise-making device. Further, the various carriers listed above are provided together as a kit having interchangeable attachments. A method for training an animal using the devices and kit is also disclosed.

### BRIEF DESCRIPTION OF THE DRAWINGS

FIG. 1 is a diagrammatic perspective view of an animal training apparatus in use by a user according to the invention.

FIG. 2 is a diagrammatic perspective view of a leg attachment harness.

FIG. 3 is a diagrammatic perspective view of a carrier having a jabbing prong integrated thereon.

FIG. 4 is a cross-sectional diagrammatic view of a jabbing prong formed from a sheathed bolt.

FIG. 5 is a diagrammatic perspective view at an alternate carrier having three jabbing prongs.

FIG. 6 is a diagrammatic perspective view of the carrier of FIG. 5 mounted to a harness in an inverted orientation.

FIG. 7 is a cross-sectional diagrammatic view of a three-pronged carrier wherein one prong is sharper.

FIG. 8 is a cross-sectional diagrammatic view of a blunted sheath for removably covering a sharped prong.

FIG. 9 is a diagrammatic perspective view of a carrier having an electronically activated detector and sound emitter.

FIG. 10 is a diagrammatic perspective view of a sleeve-shaped carrier for mounting a noise-making can.

FIG. 11 is a flow chart diagram of the inventive method.

### DESCRIPTION OF THE PREFERRED EMBODIMENT OF THE INVENTION

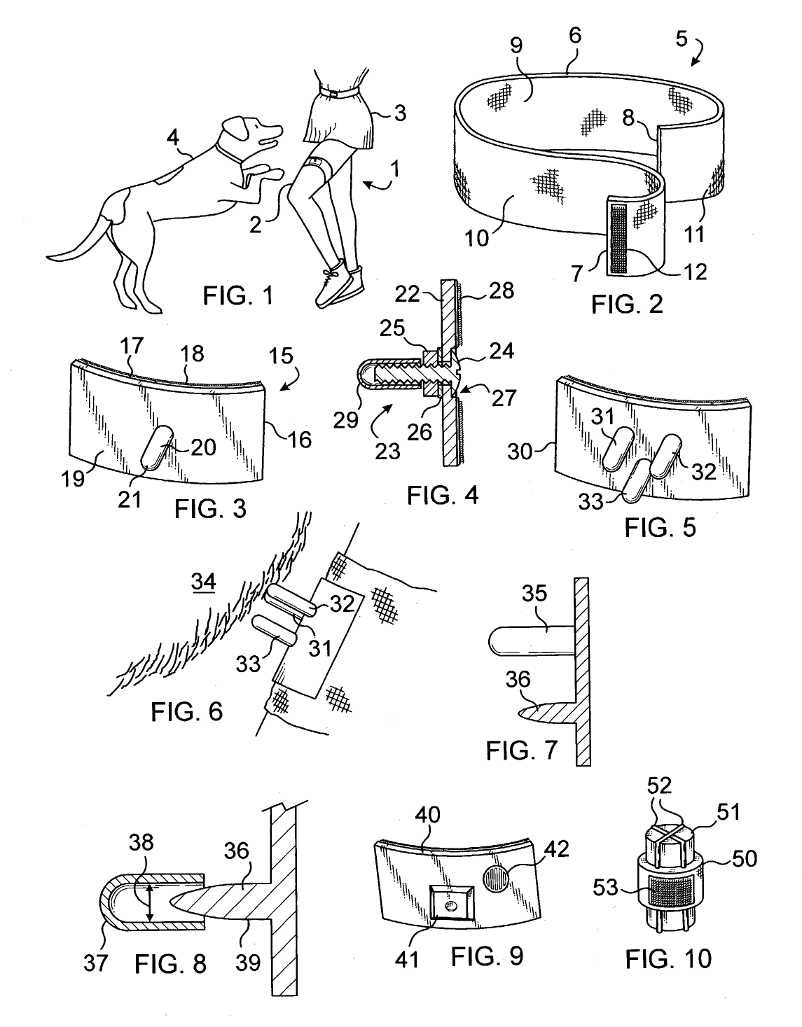

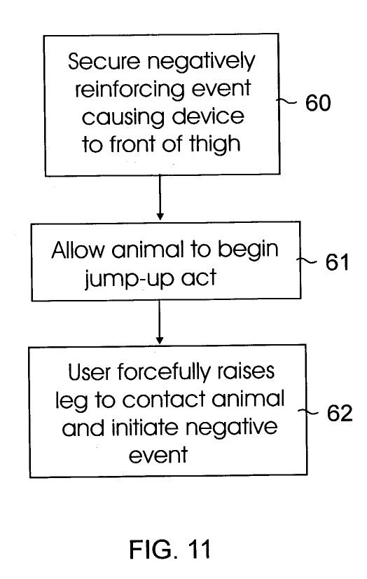

Referring now to the drawing, there is shown in FIGS. 1-3 an animal behavior training apparatus 1 designed to removably and adjustably attach to the leg 2 of a user 3 and to be used to inflict a negatively reinforcing event such as a mildly painful jab upon an animal 4 being trained.

The apparatus has a harness 5 for attachment to a user's upper leg above the knee. The harness is preferably adjustable for different sized users and comfortable to wear. Most preferably, the harness is in the form of a belt or band 6 made from flexible and resiliently stretchable material such as neoprene rubber. In order to be adjustable, band is open-ended having a first end 7 and a second end 8, and an inner surface 9 and an outer surface 10. The outer surface 10 is covered by a layer 11 of the first cooperating type of hook and vane type fabric fastener such as VELCRO brand fastener. A patch 12 of the second cooperating type of hook and vane material is secured to the inner surface 9 proximate to the first end 7 of the band and is so oriented to contact and connect to the outer surface layer 11 when the belt is in an overlapping configuration. For economic reasons, vane material is used for the outer surface layer and hook material is used for the patch.

As shown in FIG. 3, a carrier 15 is provided for carrying a negatively reinforcing event causing device or feature. In this embodiment the carrier is in the form of a plate 16 having a concave inner surface 17 having a curvature generally commensurate with the average curvature of a the front of a user's thigh near the knee. The inner surface is fitted with a portion 18 of hook and vane fabric fastener of a type which cooperatively and releasably connects to the outer surface 11 of the band. The outer surface 19 of the plate carries a negatively reinforcing event causing device or feature in the form of a prominence or prong 20 extending outwardly therefrom having a blunted tip 21 oriented to contact the underside of a jumping-up animal when a user's knee is raised. Most preferably the plate and prong are an integrated structure of injection molded durable and rigid plastic such as polycarbonate.

Referring now to FIG. 4 there is shown an alternate embodiment of a carrier 22 and prong 23 wherein the prong is formed by a threaded bolt 24 extending through an aperture in the plate and secured by a nut 25 and washer 26. The head of the bolt rests in a recess 27 on the rearward side of the plate so as not to interfere with the releasable connection between the portion 28 of fastener secured to the back surface of the plate. A closed-ended sheath 29 covers the threaded end of the bolt 24 and is made of durable flexible material such as polyvinyl plastic. The sheath is in the form of a closed cylinder having a rounded tip and a diameter closely matching the outer diameter of the threads of the bolt so as to be readily mounted thereon. In this way, bolts of differing lengths may be used to adapt the negatively reinforcing event causing device to be longer or to contact a dog having more hair for example.

Referring now to FIG. 5 there is shown an alternate embodiment wherein a carrier plate 30 has a prominence in the form of a triangular arrangement of three prongs 31,32,33. Two of the prongs 31,32 are mounted side by side, with a third prong 33 mounted below in an equilateral triangle configuration, which allows the user a wider zone of contact for engaging the animal. Also, more prongs increase the surface area contacting the animal in a direct thrust, lessening the pain of the jab. Indirect thrusts of lesser strength may still cause adequate pain because only one prong may contact the animal. Further, the user can select between two orientations of the plate which will cause more or less pain when an off-pitch contact is made. In the first orientation, as shown in FIG. 6, off-pitch contact causes the top, side-by-side prongs 31,32 to contact the animal 34 while the bottom prong 33 does not. Because the two side-by-side prongs provide more surface area, an event of lesser pain is inflicted. In a reversed orientation wherein the single prong 33 is on top, the event would be of greater pain.

Referring now to FIG. 7, there is shown an alternate embodiment of the multi-prong plate which provides one or more blunted prongs 35 on top, and a shortened sharper single prong 36 on the bottom. This device provides the user with the ability to provide a stronger jab in which the sharper prong will contact the animal, and wherein a less strong jab will only contact the animal using the blunted top prong. This provides a greater range of pain at the control of the user.

Referring to FIG. 8, a blunted sheath 37 is provided for covering the sharpened prong 36. The sheath is sized and shaped to allow removable placement on the sharpened prong thereby allowing the user control over the amount of pain given. For a generally cylindrical prong, the sheath's inner diameter 38 is selected to closely contact the outer surface 39 of the sharpened prong thereby securing the sheath to the prong.

Referring now to FIG. 9, the carrier 40 is shown to be adapted to carry other negatively reinforcing event causing devices or features such as a contact sensor 41 and electronic sound generator which emits a distasteful noise near the animal through a speaker 42.

Referring now to FIG. 10, there is shown an alternate embodiment wherein the carrier is in the form of a flexible sleeve 50 adapted to carry a negatively reinforcing event causing device in the form of a pebble-filled can 51. The sleeve has an inner diameter selected fit over a common beverage can. Resilient retaining ropes 52 are provided to

1. An animal training apparatus comprises:
a first negatively reinforcing event-causing device;
a harness releasably attachable to a user's body; and,
a connector for releasably attaching said device to said harness.

2. The apparatus of claim 1, wherein said harness is sized and shaped to be releasably attachable to said user's leg proximate to the knee.

3. The apparatus of claim 1, wherein said device further comprises:
an arcuate plate having a front surface and an opposite concave back surface; and,
a first negatively reinforcing prominence mounted to said front surface.

4. The apparatus of claim 3, wherein said first prominence comprises a first prong extending out a length from said front surface.

5. The apparatus of claim 3, wherein said first prominence further comprises a second prong spaced apart a distance from said first prong.

6. The apparatus of claim 4, wherein said first prominence further comprises a third prong wherein said first, second and third prong are oriented in a triangular formation having a horizontal side on top.

7. The apparatus of claim 4, wherein said first prong has a blunted tip.

8. The apparatus of claim 4, wherein said first prong comprises an oblong rigid body and a sheath made from durable, pliable material.

9. The apparatus of claim 5, wherein said second prong is sharper than said first prong.

10. The apparatus of claim 1, wherein said connector comprises:
a hook and vane type fastener having a first active surface bonded to said harness and a second active surface bonded to said device.

11. The apparatus of claim 10, wherein said first active surface is vane-type material.

12. The apparatus of claim 1, wherein said apparatus further comprises a second negatively reinforcing event causing device interchangeable with said first device, in the form of a kit.

13. An animal training device comprise:
a negatively reinforcing event-causing device;
means for releasably and adjustably attaching said device to an anterior surface of a user's leg proximate to a user's knee; and
wherein said device is activated upon a raising of said user's leg thereby contacting an animal.

14. A method for training an animal to refrain from jumping up on a standing user, said method comprises:
releasably attaching a negatively reinforcing device to the anterior portion of a user's leg above the knee;
allowing a subject animal to jump upon said user;
raising said user's leg;
thereby additionally contacting said animal; and
wherein said raising comprises activating said device thereby causing a negatively reinforcing event to occur upon said animal.
